(19) United States
(12) Patent Application Publication
(10) Pub. No.: US 2012/0313479 A1
(43) Pub. Date: Dec. 13, 2012

(54) METHOD FOR PRODUCING A CARBON BRUSH IN A COMMUTATOR

(75) Inventors: Michael Bayer, Ludwigsburg (DE); Matthias Schick, Ludwigsburg (DE)

(73) Assignee: ROBERT BOSCH GMBH, Stuttgart (DE)

(21) Appl. No.: 13/574,211

(22) PCT Filed: Feb. 23, 2011
(86) PCT No.: PCT/EP11/52637

§ 371 Date: Jul. 19, 2012

(30) Foreign Application Priority Data
Mar. 3, 2010 (DE) 102010002536.4

(51) Int. Cl. H01R 43/12; H01R 39/26

(52) U.S. Cl. 310/253; 423/460; 252/503

(57) ABSTRACT

The invention relates to a method for producing a carbon brush in a commutator for transmitting current in an electric motor, wherein the carbon brush is subjected to an artificial aging process after being produced and prior to being installed in the commutator, wherein the carbon brush is stored at an increased temperature for a defined period of time.

### BACKGROUND OF THE INVENTION

The invention relates to a method for producing a carbon brush in a commutator for current transmission in an electrical machine.

Commutators are used in electric motors for transmitting current to the armature, which is mounted in a stator such that it can rotate, and for commutation in shorted armature coils. The commutators consist of an armature-side commutator and carbon brushes which are fixed to the housing and rest on the envelope surface of the rotating commutator.

DE 40 25 367 C2 discloses a carbon brush for a small motor, which carbon brush consists of a graphite powder to which metal powder is added, and which is pressure-formed and then sintered. Carbon brushes such as these have copper added to them, for example, as a metal component.

The commutator and the carbon brushes are subject to wear during operation. The extent of the wear must be appropriately designed for the purpose. By way of example, electric starter motors in internal combustion engines are subject to relatively high loads and must ensure a large number of switching cycles without functional restriction. Because of the long running times of the carbon brushes, care must be taken to ensure that material which has been removed as well as a sliding film which is formed on the commutator are automatically cleaned. Different substances can be mixed into the carbon brushes for ideal cleaning of the surface, ensuring that the surface of the commutator has a coating which remains the same, is clean and at the same time provides lubrication. However, it should be noted that, by virtue of their design, carbon brushes composed of a sintered material, in particular, have a relatively large number of pores, through which the material is subject to relatively severe environmental influences, which can lead to material changes, in particular to an increase in the electrical resistance of the carbon brushes.

### SUMMARY OF THE INVENTION

The invention is based on the object of designing carbon brushes in commutators for a long operating life, by simple measures.

The method according to the invention is used for producing a carbon brush in a commutator for current transmission in an electrical machine. An application to electrical starters for internal combustion engines is considered, in particular, in this case which, by virtue of the system, are subject to a large number of starting cycles. Particularly when used in start-stop systems in motor vehicles in which, for example, the internal combustion engine is switched off automatically when stationary at traffic lights and is automatically switched on again upon clutch or gear actuation, correct operation of the commutator device must be ensured over a long operating time period.

In order to ensure that the physical characteristics of the carbon brushes in the commutator, particularly the mechanical and electrical characteristics, do not change negatively over a long operating time period, the method according to the invention results in the change in the characteristics being anticipated even before the carbon brushes are used in the commutator, until an at least approximately constant characteristic level is achieved, and no further significant change in the carbon brushes need be expected in the commutator during use. The method according to the invention therefore anticipates the normal aging of the carbon brushes resulting in an increased internal resistance. The performance characteristics of the electrical machine in which the carbon brush is used are therefore no longer subjected to any significant change throughout the operating time period.

A further advantage of anticipation of aging effects in the carbon brushes is the reduction of changes in the resistance system of the electric motor. For example, when a starter is used in a motor vehicle on-board power supply system, then the anticipated aging of the carbon brushes also anticipates the increase in the resistivity in the carbon brushes, as a result of which the maximum current level called up by the starter is reduced, thus also reducing the load on the on-board power supply system when the starter is switched on. This is particularly advantageous for start-stop systems in vehicles in which low starter loads are required for the on-board power supply system.

The artificial aging process to which the carbon brushes are subjected before assembly of the commutator is, according to the invention, carried out by storage of the carbon brushes at a raised temperature for a defined time period. The carbon brushes are preferably stored in a temperature range between 120° and 280°, with the storage duration preferably being for a time period of 24 h to 250 h. The humidity during storage can be taken into account as a further influencing variable for the artificial aging process, in which case the temperatures can be reduced when the air humidity is higher. For example, it is expedient to subject the carbon brushes to storage at temperatures from 30° to 70° for a time period of 24 h to 160 h in a relative air humidity of 70% to 95%. By way of example, the temperature is 42° and the relative air humidity is 92%. By way of example, with a significantly lower air humidity, the storage is carried out for 150 h at 200° C.

Under the stated storage conditions, the structure of the carbon brush changes. In this case, metal components in the material of the carbon brush are oxidized by the specific storage conditions, as a result of which a corresponding metal oxide is formed in the carbon brush, which results in the resistivity of the carbon brushes rising. Copper is preferably used as a metal in the carbon brush, and is oxidized by the storage conditions, as a result of which copper oxide is formed in the carbon brush, and this is responsible for the increase in the resistivity of the carbon brush.

The proportion of the copper oxide rises significantly as a result of the anticipated aging, for example by about three times the original value, which can be confirmed by appropriate investigations in the carbon brush which has been subjected to storage. A rise, for example, from 1.1% to 2.9% is typically achieved in the copper oxide. Both a uniform distribution of the proportion of copper oxide and a non-uniform distribution may occur within the carbon brush, in particular an increased proportion of copper oxide in the region of the surface of the carbon brush, with a decreasing proportion toward the center of the carbon brush.

The anticipated artificial aging results in an increase in the electrical resistivity of the carbon brush, for example from an initial value range of 0.5 μohm*m to 0.9 μohm*m to a final or intended value range of 1.1 μohm*m to 1.5 μohm*m. This electrical resistivity, which the carbon brush has after carrying out the artificial aging, does not rise significantly any further during the course of the use of the carbon brush in the electric motor, as a result of which there is also no need to expect any further change in the electrical characteristics of the carbon brush. Advantageously, the storage not only changes the electrical characteristics but also the mechanical characteristics of the carbon brush such that the greatest proportion of the change in mechanical characteristics is anticipated by the artificial aging process, as a result of which the mechanical characteristics no longer change in a significant manner during operation.

The rise in the electrical resistivity can be measured and can be used to identify a carbon brush which has been pretreated in the manner according to the invention.

Further advantages and expedient embodiments can be found in the further claims, the description of the figures and the drawing, which shows a perspective illustration of a commutator in an electrical machine, consisting of an armature-side commutator and two diametrically opposite carbon brushes, which make contact with the commutator envelope surface.

### DETAILED DESCRIPTION OF THE DRAWING

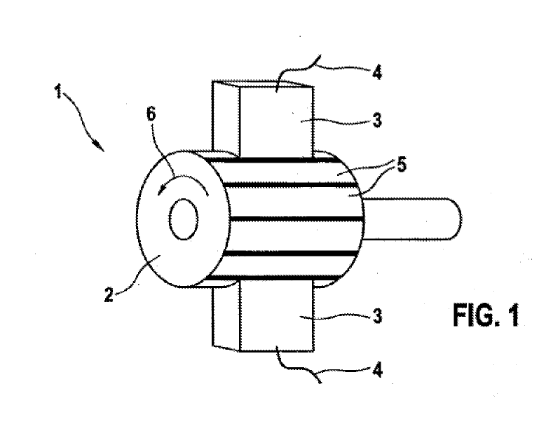

The commutator 1 illustrated in FIG. 1 is used to transmit current and for commutation in electrical machines such as electric motors or generators, and is preferably used in starters for internal combustion engines. Starters such as these are designed for a large number of starting processes, in particular in the case of motor vehicles which are equipped with start-stop systems for automatically switching the internal combustion engine off and on.

The commutator 1 comprises a cylindrical commutator 2, which is connected to the armature of the electrical machine such that they rotate together, with the armature being mounted in a stator such that it can rotate. The commutator 1 furthermore comprises carbon brushes 3 which, in the illustrated exemplary embodiment, make diametrically opposite contact with the radially external envelope surface of the cylindrical commutator 2, or a disk running surface, and transmit the electric current to the commutator 2, with the current being passed to the respective carbon brush 3 via a braid 4. The commutator 2 may, if required, also be in the form of a disk.

The commutator 2 has a multiplicity of segments 5 which are separated in the circumferential direction and are each electrically connected to armature coils. When the armature and the commutator 2 rotate in the rotation direction 6, the envelope surface of the commutator slides along the facing end surface of the carbon brushes 3, while current is at the same time transmitted from the carbon brushes 3 to the segments 5 of the commutator 2.

The carbon brushes 3 are subjected to anticipated aging in order to ensure that no aging effects during operation lead to a change in the commutator system. The anticipated aging of the carbon brushes takes place before installation in the commutator, in that the carbon brushes, which are normally formed as sintered components composed of graphite and have copper components, are subjected to an artificial aging process, in which the carbon brushes are stored at a raised temperature for a defined time period. The storage takes place, for example, in a temperature range between 120° and 280° and over a time period of, for example, 24 h to 250 h, with storage being carried out for a longer time in the case of a lower temperature, and for a shorter time in the case of a higher temperature.

Humid storage of the carbon brushes is also possible in order to produce an artificial aging process, for example in a temperature range between 30° and 70° for a time period from 24 h to 160 h and in a relative air humidity of 70% to 95%. In principle, lower temperatures are sufficient when the relative air humidity is higher. For example, a storage temperature of 42° may be chosen for a relative air humidity of 92%.

The artificial aging process oxidizes the copper components in the carbon brushes, as a result of which the proportion of copper oxide rises significantly. The rise is, for example, from 1.1% to 2.9%.

At the same time, the electrical resistivity is increased by the artificial aging from a value range of, for example, 0.5 μohm*m to 0.9 μohm*m to a value range after carrying out the artificial aging of, for example, 1.1 μohm*m to 1.5 μohm*m.

1. A method for producing a carbon brush in a commutator (1) for current transmission in an electrical machine, the method comprising:
producing the carbon brush; and
subjecting the carbon brush, after production of the carbon brush and before assembly of the commutator (1), to an artificial aging process, in which the carbon brush is stored at a raised temperature for a defined time period.

2. The method as claimed in claim 1, characterized in that the carbon brush is stored in a temperature range between 120° and 280°.

3. The method as claimed in claim 1, characterized in that the carbon brush is stored for a time period of 24 h to 250 h.

4. The method as claimed in claim 1, characterized in that the carbon brush is subjected to humid storage at temperatures from 30° to 70° for a time period of 24 h to 160 h, and to a relative air humidity of 70% to 95%.

5. The method as claimed in claim 4, characterized in that the temperature is 42° and the relative air humidity is 92%.

6. The method as claimed in claim 1, characterized in that the carbon brush has an electrical resistivity of 0.5 μohm*m to 0.9 μohm*m before the artificial aging.

7. The method as claimed in claim 1, characterized in that the carbon brush has an electrical resistivity of 1.1 μohm*m to 1.5 μohm*m after the artificial aging.

8. The method as claimed in claim 1, characterized in that the material of the carbon brush has a copper component.

9. A commutator for current transmission in an electrical machine, having an armature-side commutator and having at least one carbon brush which rests on the commutator and is produced using the method as claimed in claim 1.

10. An electrical machine having a commutator as claimed in claim 9.

11. A commutator according to claim 9, characterized in that the carbon brush is stored in a temperature range between 120° and 280°.

12. A commutator according to claim 9, characterized in that the carbon brush is stored for a time period of 24 h to 250 h.

13. A commutator according to claim 9, characterized in that the carbon brush is subjected to humid storage at temperatures from 30° to 70° for a time period of 24 h to 160 h, and to a relative air humidity of 70% to 95%.

14. A commutator according to claim 13, characterized in that the temperature is 42° and the relative air humidity is 92%.

15. A commutator according to claim 9, characterized in that the carbon brush has an electrical resistivity of 0.5 μohm*m to 0.9 μohm*m before the artificial aging.

16. A commutator according to claim 9, characterized in that the carbon brush has an electrical resistivity of 1.1 μohm*m to 1.5 μohm*m after the artificial aging.

17. A commutator according to claim 9, characterized in that the material of the carbon brush has a copper component.
